(19) United States
(12) Patent Application Publication
(10) Pub. No.: US 2013/0276602 A1
(43) Pub. Date: Oct. 24, 2013

(54) SAWING MACHINE AND CUTTING METHOD OF A SAWING MACHINE

(71) Applicant: Isomi WASHIO, Tokyo (JP)

(72) Inventor: Isomi WASHIO, Tokyo (JP)

(21) Appl. No.: 13/857,606

(22) Filed: Apr. 5, 2013

(30) Foreign Application Priority Data
Apr. 6, 2012 (JP) 2012-087354

(51) Int. Cl. B23D 59/00; B26D 5/02

(52) U.S. Cl. CPC B23D 59/002; B26D 5/02
USPC 83/13; 83/368

(57) ABSTRACT

Traditionally, in order to avoid interfering with a work-piece such as a round material and an hexagonal material etc., an insert plate used as a saw blade side support of a band saw machine or a circular saw machine is provided at a position apart from the cutting site after passing the maximum cutting width, which results in the bending, vibration and noise of the saw blade, thereby decreasing the life of the saw blade. This problem is solved with two insert plates located at two positions on left and right of a work-piece to support the saw blade in a manner of moving them closing to the work-piece along the external shape of the work-piece from the cutting start and after passing the maximum cutting width by enabling them to move along the external side of the work-piece, therefore, one side of the insert plates takes a tapered shape so as to get into under the work-piece.

### FIELD OF THE INVENTION

The present invention relates to a sawing machine, in particular to a saw blade support device of a band saw machine or a circular machine for cutting a work-piece by means of revolving or rotating the saw blade. More particularly, it relates to a technique which enables a saw blade side support device for supporting the saw blade from both sides to move along the shape of external side of a work-piece.

### BACKGROUND OF THE INVENTION

A band saw machine or a circular saw machine for cutting a work-piece by means of revolving or rotating a saw blade has been used as a device for cutting round materials and angular materials so far.

For an example, on a horizontal band saw machine, a work-piece is clamped and fixed by a body fixed vice and a body movable vice, and the work-piece is cut by an endless saw blade which is winded on a driving wheel and a driven wheel provided on a saw frame enabled to move up and down, by revolving the endless saw blade and moving the saw frame down at the same time. The revolving saw blade is supported by a saw blade back support provided on a fixing side blade guide arm and a saw blade side support provided on the moving side saw blade guide arm.

Generally, the saw blade back support includes a backup roller or a backup chip, and the saw blade side support includes a fixed insert plate and a movable insert plate which support the body of saw blade from both sides, and further includes an insert plate pressing device for pressing the moveable insert plate toward the fixed insert plate.

The so-called optimum cutting condition of a band saw machine means a state in which the distance between the left and right two support positions where the saw blade is supported from the back side and the both sides is minimized within a limit of not interfering with the work-piece and the vice. This make it possible to inhibit the bending of the saw blade in cutting, reduce the vibration of the saw blade and the noise caused by the vibration, improve the life of the saw blade and the accuracy of the cut surface of the work-piece, and also increase the cutting speed. In addition, if the distance between the left and right saw blade back supports is shortened, it is possible to prolong the fatigue life of the body of saw blade because the internal stress of the saw blade borne in cutting can be decreased. Therefore, as shown in FIG. 11, the cut processing is performed under the condition that the saw blade guide arm (saw blade support device) is fixed at a position as close to the work-piece as possible but not interfering with the parts of the vice and the work-piece. Moreover, as shown in FIG. 12, the other known method is to move the saw blade guide arms to the left and the right along the external shape of the work-piece according to the cutting process, and to make the saw blade support device always support the saw blade at the position close to the work-piece at the upper half part from the top to the center point of the work-piece. Furthermore, as disclosed in Japanese Unexamined patent publication No. 2002-192420, the end of a saw guide with a concave is shaped such that it can get into under the work-piece.

On the other hand, a circular saw machine clamps and fixes a work-piece with a body fixed vice and a body movable vice, then cut the work-piece by means of rotating a circular saw blade provided on a saw frame enabled to move up and down and moving the saw frame down at the same time. In a circular saw machine, although the support of back side similar to the back side support of the band saw blade in a band saw machine is not necessary, the saw blade is supported from both sides by the saw blade side supports mounted on a fixing side saw blade guide arm and a moving side saw blade guide arm disposed on the both sides of the work-piece.

The saw blade side support of a circular saw blade is fixed on a saw blade cover provided on the saw frame, thereby supporting the circular saw blade at a position outside the work-piece with the maximum cutting width of the circular saw machine, in a way of not interfering with the work-piece during the cutting.

Another saw cutter devise is disclosed in Japanese Patent No. 2810380. Therein disclosed is a saw cutter guide having a cutting position detector for detecting the position of the cutter with respect to the material to be cut.

### SUMMARY OF THE INVENTION

### Problems to be Solved

However, in the cutting devices described above, in the process for cutting a bulged work-piece such as a round material or a hexagonal material etc., the saw blade side supports move apart from the cutting surface of the work-piece toward the left and right between the position of the saw blade passing the center point of the work-piece and the position of the last cutting, therefore, the bending, vibration and noise of the saw blade occurred between the position of the saw blade passing the center point of the work-piece and the position of the last cutting are unable to be decreased.

Particularly, in a band saw machine, the saw blade back support and the saw blade side support are installed in a same holder thereby the two supports moving together, as a result, because of the constraint from the position of the saw blade back support, the saw blade side support is not allowed to close the work-piece further even if there is a space.

Moreover, on a circular saw machine, the saw blade side support is fixed on a saw blade cover base of a saw frame which supports the circular saw blade and the open side saw blade cover, so as to prevent interfering with the external side of the work-piece in the maximum size. Therefore, only an auxiliary effect in the aspect of the blade vibration may be expected. To make it possible to cut the work-piece of large-diameter, there is no other method expect for increasing the thickness of the circular saw blade in order to increase the rigidity relative to the bending of the saw blade, this results in not only the need of large-size driving device, but also increase of the cutting amount of the circular saw blade, thereby, the machine will become uneconomical.

In view of the above problems, the present invention provides a sawing machine including a saw blade support device and a cutting method of a saw machine which enable saw blade side supports to move along the external side of the work-piece, so as to always support the saw blade at a position near the cutting site between the position of the cutting start and the position of the last cutting after passing through the center point of the work-piece, thereby, not only decreasing the bending, vibration and noise of the saw blade, but also prolonging the life of the saw blade, and reducing the cutting amount of the work-piece.

### Method of Solving Problems

To solve above problems, in one aspect of the present invention of this application, a sawing machine comprises a saw blade support device of a sawing machine for cutting work-pieces with a saw blade, said saw blade support device comprising: a pair of saw blade side supports for supporting the saw blade from both sides; and a moving unit for moving the saw blade side supports along the external side of the work-piece and in the direction orthogonal to the cutting direction of the work-piece, wherein each of the saw blade side supports is supported on the end portion of a guide arm in a manner of projecting toward the work-piece; the sawing machine has a sensor for detecting the external shape of the work-piece and/or a storage device for storing the external shape of the work-piece; and the moving unit is controlled based on the detected result from the sensor or the external shape data in the storage device.

In another aspect of the present invention of this application, the saw blade side supports take a shape of tapered inclined surface so that the end portion toward the work-piece can be located within the maximum cutting width of the work-piece between the position of the saw blade passing the maximum cutting width of the work-piece and the position of the cutting end.

In another aspect of the present invention of this application, the tapered inclined surface takes a shape of a straight line, a combination of a plurality of straight lines or an arc in a side view conforming to the shape of external side of the work-piece.

In another aspect of the present invention of this application, the saw blade is a revolving band saw blade or a circular saw blade including a rotating plate.

In another aspect of the present invention of this application, the saw blade side supports are disposed at two positions on left and right of the work-piece.

In another aspect of the present invention of this application, the saw blade side supports disposed at two positions on left and right are respectively connected to the moving units that are independent, and the moving units are controlled independently according to the external side of the work-piece.

In another aspect of the present invention of this application, the saw blade side support includes an insert plate made of a super-hard alloy or ceramics.

Regarding the method aspect of the present invention, same is generally expressed in an embodiment of the invention. Accordingly, a cutting method of a sawing machine for cutting a work-piece with a saw blade is provided, wherein saw blade side supports for supporting the saw blade from both sides are moved along the external side of the work-piece and in the direction orthogonal to the cutting direction of the work-piece by using a moving unit; each of the saw blade side supports is supported on the end portion of a guide arm in a manner of projecting toward the work-piece; the sawing machine has a sensor for detecting the external shape of the work-piece and/or a storage device for storing the external shape of the work-piece; and the moving unit is controlled based on the detected result from the sensor or the external shape data in the storage device.

In another aspect of the present invention of this application, the saw blade is a circular saw blade including a rotating plate or a revolving band saw blade.

In another aspect of the present invention of this application, the saw blade side supports are disposed at two positions on left and right of the work-piece.

In another aspect of the present invention of this application, the saw blade side supports disposed at two positions on left and right are configured to move independently, and the movement is controlled independently according to the external shape of the work-piece.

According to above aspects of the invention, even in the case of cutting a bulged work-piece such as a round material and a hexagonal material with a sawing machine, the saw blade is configured to be supported along the external side of the work-piece by the saw blade side supports between the position of the cutting start of the work-piece and the position of the last cutting, therefore, it is possible to decrease the bending, vibration and noise of the saw blade, which are unable to be decreased in conventional art, and prolong the life of the saw blade and reduce the cutting amount of the work-piece.

### BRIEF DESCRIPTION OF THE DRAWINGS

FIG. 1 is a front view of embodiment 1 in which the saw blade support device according to the present invention is provided for a band saw machine.

FIG. 2 is a side view of embodiment 1 in which the saw blade support device according to the present invention is provided for a band saw machine.

FIG. 3 is a plan view of embodiment 1 in which the saw blade support device according to the present invention is provided for a band saw machine.

FIG. 4 is a schematic diagram showing a moving state of the saw blade side supports moving along the external side of a work-piece when the saw blade is cutting a work-piece in embodiment 1 according to the present invention.

FIG. 5 is a schematic diagram showing the moving positions of the saw blade back guiders and the side supports during the last cutting stage when cutting work-pieces having different diameters in embodiment 1 according to the present invention.

FIG. 6A is a plan view showing a detailed action of a moving state of the saw blade side supports moving along the external side of a work-piece when the saw blade is cutting the work-piece in embodiment 1 according to the present invention.

FIG. 6B-E are front views showing a detailed action of a moving state of the saw blade side supports moving along the external side of a work-piece when the saw blade is cutting the work-piece in embodiment 1 according to the present invention.

FIG. 7A is a plan view of an illustration diagram of modification 1 in the case that a work-piece has a small diameter.

FIG. 7B is a front view of an illustration diagram of modification 1 in the case that a work-piece has a small diameter.

FIG. 8 is an illustration diagram of modification 2 in the case that a work-piece has a small diameter, wherein the saw blade back support namely a backup roller is aligned to the center of cutting length of the work-piece.

FIG. 9 is an illustration diagram of modification 3 in the case that a work-piece has a small diameter, wherein the saw blade back support is a backup chip.

FIG. 10A is a plan view of an illustration diagram showing a state that a roller used as a sensor for detecting the position of a work-piece is installed on the end of the backup support.

FIGS. 10B-D are front views of an illustration diagram showing a state that a roller used as a sensor for detecting the position of a work-piece is installed on the end of the backup support.

FIG. 11A is a plan view of an illustration diagram showing a state that a roller used as a sensor for detecting the position of a work-piece is installed on the end of the backup support, and a method which makes the guide arm move from side.

FIGS. 11B-E are front views of an illustration diagram showing a state that a roller used as a sensor for detecting the position of a work-piece is installed on the end of the backup support, and a method which makes the guide arm move from side.

FIG. 12 is a diagram showing a modification of a position detecting roller of a work-piece.

FIG. 13 is an illustration diagram showing various modifications of the saw blade back support namely insert plates.

FIG. 14A is a plan view of an illustration diagram of embodiment 2 in which the saw blade support device according to the present invention is provided for a band saw machine, and the saw blade cover is opened 180°.

FIG. 14B is a front view of an illustration diagram of embodiment 2 in which the saw blade support device according to the present invention is provided for a band saw machine, and the saw blade cover is opened 180°.

FIG. 15A is a plan view of an action diagram showing the moving state of the saw blade side supports moving along the external side of a work-piece when the saw blade is cutting the work-piece in embodiment 2 according to the present invention.

FIGS. 15B-D are front views of an action diagram showing the moving state of the saw blade side supports moving along the external side of a work-piece when the saw blade is cutting the work-piece in embodiment 2 according to the present invention.

FIG. 16A is a plan view showing a conventional saw blade support device.

FIGS. 16B-E are front views showing a conventional saw blade support device.

FIG. 17A is a plan view relating to another saw blade support device.

FIG. 17B-E are front views relating to another saw blade support device.

### DESCRIPTION OF EMBODIMENTS

### Embodiment 1

An embodiment relating to the present invention will be described in detail with reference to the accompanying drawings hereinafter.

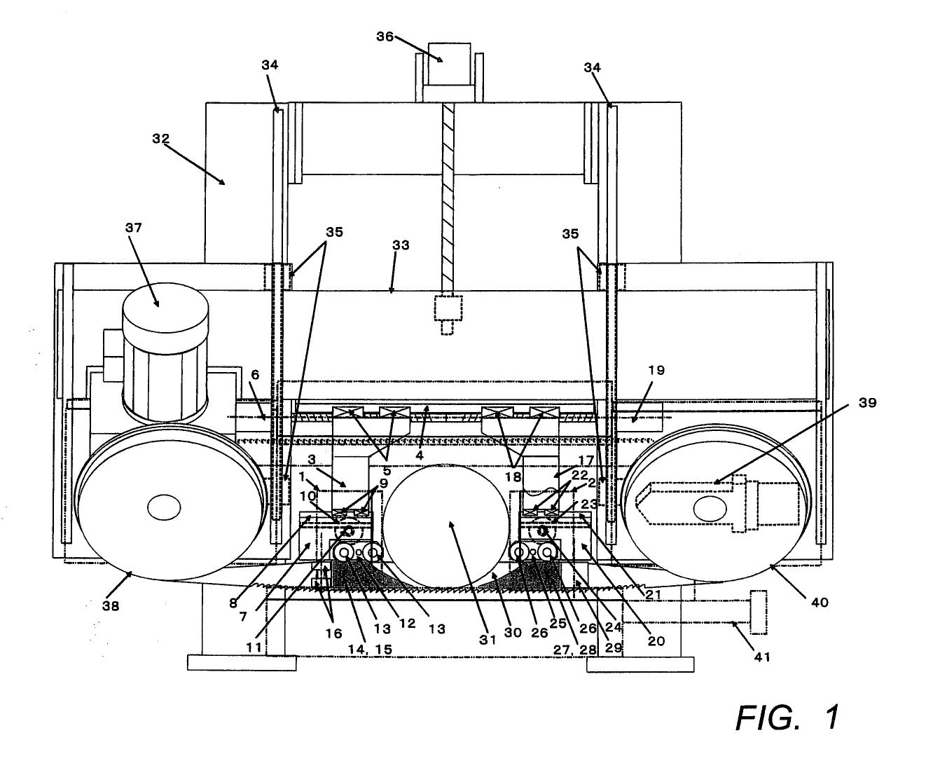

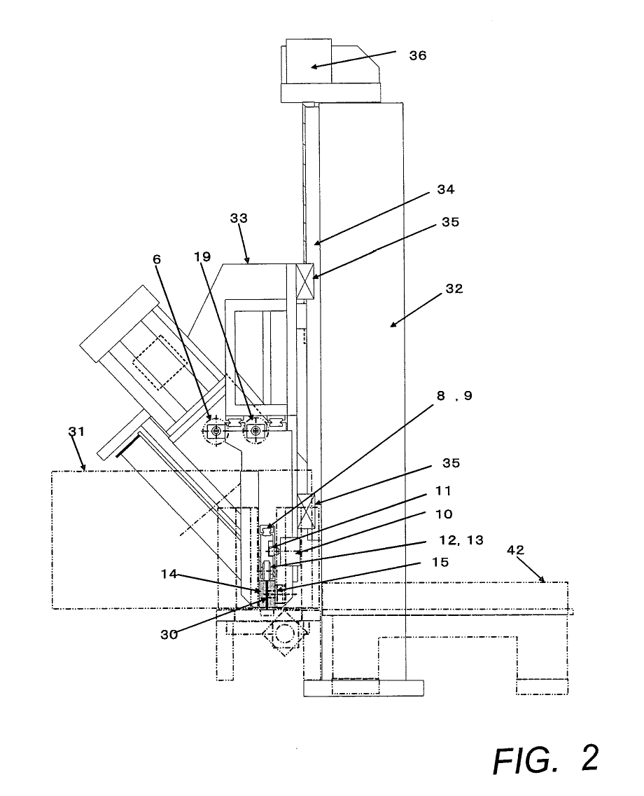

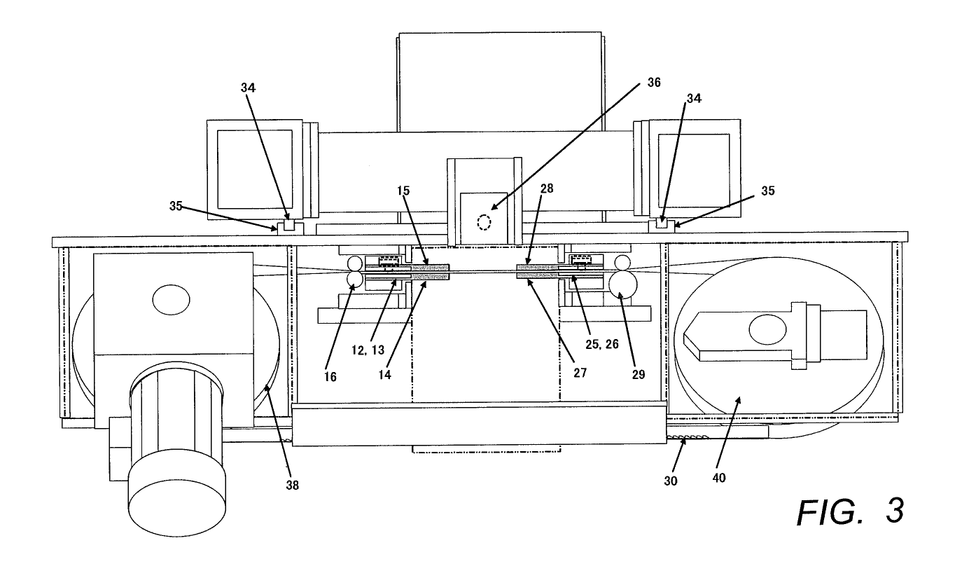

FIG. 1 to FIG. 3 show embodiment 1 in which the saw blade support device according to the present invention is applied to a band saw machine. FIG. 1 is a front view of the band saw machine relating to embodiment 1, FIG. 2 is a side view and FIG. 3 is a plan view.

The band saw machine includes a feeding device (not shown in figure) for carrying work-piece 31, a body vice device for fixing the work-piece 31 and a cut processing portion for cutting the work-piece 31. The feeding device generally includes a roller table equipped with a plurality of free rotating rollers and a feeding vice unit for carrying the work-piece on the roller table to the saw blade position. The body vice device comprises a body fixed vice 1 and a body moveable vice 2 for clamping and fixing the work-piece 31. Specifically, as shown by the chain line in FIG. 1, the work-piece 31 is fixed by clamping it with the body fixed vice 1 and body moveable vice 2 from both sides.

The cut processing portion is a system for cutting the work-piece 31 with a saw blade 30 which is winded on a driving wheel 38 and a driven wheel 40 and revolves with the rotating of the driving wheel 38. Specifically, the band saw blade 30 is winded on the driving wheel 38 and driven wheel 40 provided on a saw frame 33 enabled to move up and down with respect to a base table namely a base column 32, a tension is applied to the band saw blade 30 through a saw blade tension unit 39, and the band saw blade 30 is revolved by a saw blade driving motor and reducer 37, and the saw frame 33 is moved down along the saw frame guide rail 34 with a saw frame up and down actuator 36, as a result, the work-piece 31 is cut by the band saw blade 30.

Moreover, the cut processing portion includes insert plates (driving side insert plate 14, 15 and driven side insert plate 27, 28) used as the saw blade side supports which support the body of saw blade 30 from both sides and the backup rollers 13, 26 used as the saw blade back supports supporting the back part of the saw blade 30 (The saw blade side supports together with the saw blade back supports for supporting the saw blade are referred to as saw blade support device hereafter). In addition, this portion further comprises actuators 6, 19 and 11, 24 used as moving units for moving guide arms 3, 17 and the backup supports 7, 20 equipped with the saw blade support device in the direction orthogonal to the cutting direction of the work-piece.

The endless saw blade 30 winded on the driving wheel 38 and the driven wheel 40 is supported in such a way that the endless saw blade 30 is twisted by twisting roller 16, 29 at the positions before and behind the cutting point of the work-piece 31 so that the blade edge of the saw blade 30 contacts with the surface of the work-piece 31 vertically. And the saw blade side supports are configured to support the band saw blade from two positions on left and right of the work-piece 31 in the revolution direction of the band saw blade.

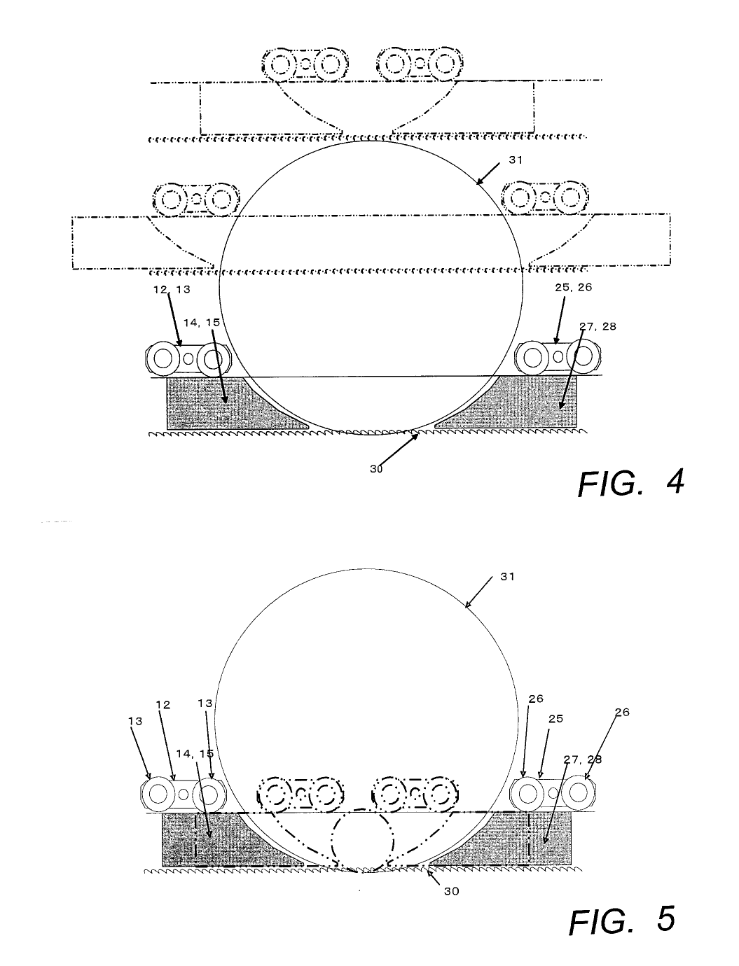

FIG. 4 is a schematic diagram showing a moving state of the saw blade side supports moving along the external side of the work-piece when the saw blade is cutting the work-piece in embodiment 1 according to the present invention. It is obvious from FIG. 4 that the end portion of the driving side insert plates 14, 15 and the driven side insert plates 27, 28 toward the work-piece 31 take a shape of tapered inclined surface, therefore, these insert plates can be located within the maximum width of the work-piece 31. In addition, although the two-dot chain line in FIG. 5 shows a case of cutting the work-piece 31 with a small diameter, even for the work-piece 31 of all sizes, the insert plates 14, 15, 27, 28 can always support the blade edge of the saw blade 30 stably at positions near the cutting site between the position of the cutting start and the position of the cutting end due to the end portion taking a shape of tapered inclined surface.

Because the work-piece 31 has a circular shape, the shape of the end of the insert plates 14, 15, 27 and 28 shown in a side view is an arc with a diameter larger than the radius of the work-piece 31, however, the end of the insert plates may have various shapes conforming to the shape of the work-piece 31 such as a straight line or combination of straight lines and so in the side view.

As described above, the saw blade support device includes a saw blade back support for supporting the back part of the saw blade 30 and a saw blade side support for supporting the body of the band saw blade from both sides, specifically, the saw blade back support includes backup rollers 13, 26 which hold the top of the saw blade 30 by means of pressing from above while rotating following the revolution of the saw blade 30, and comprises backup holders 12, 25 for holding the backup rollers 13, 26. On the other hand, the saw blade side support includes fixed insert plates 14, 15 and moving insert plates 27, 28 which support the saw blade 30 from both sides. The saw blade back support is subjected to a back force component of the cutting reaction force from the work-piece 31 through the backup rollers 13, 26 and the saw blade side support is subjected to a torsional force of the saw blade 30 and the torsional moment tending to bend the saw blade 30 due to the uneven wear of the blade edge through the fixed insert plates 14, 15 and the moving insert plates 27, 28. Moreover, the backup roller can be substituted by a backup chip, but it is not limited to these configurations.

The actuator 36 moving the saw frame 33 back and forth in the cutting direction is a device used to move the saw blade support device provided to the guide arms 3, 17 and the backup supports 7, 20 in the cutting direction (vertically downwards in this embodiment), and the actuators 6, 19 of the guide arms 3, 17 and the actuators 10, 23 of the backup supports 7, 20 are devices used to move the saw blade support device in the direction orthogonal to the cutting direction (the revolution direction (horizontal direction) of the saw blade in this embodiment). Specifically, it is made a pair of saw blade support devices disposed on two sides of the work-piece 31 to close to or apart from each other.

More specifically, the band saw machine is configured such that, when cutting the work-piece 31, the driving side insert plates 14, 15 mounted on the driving side guide arm 3 and the driven side insert plates 27, 28 mounted on the driven side guide arm 17 move along the external shape of the work-piece 31(the external shape data input in advance or the side shape detected by a sensor), and the driving side guide arm 3 and the driven side guide arm 17 are moved along the saw blade arm guide rail 4 by the respective actuators 6 and 19 while the saw blade 30 move down in the cutting direction.

The driving side backup roller 13 and the driven side backup roller 26 being subjected to the back force component of the cutting which is exerted on the saw blade upwards are supported by the backup holders 12, 25 by means of enabling to support the saw back flexing caused by the back force component which is borne by the saw blade 30, and the backup holders 12, 25 are mounted respectively on the driving side and driven side backup supports 7, 20.

The band saw machine is configured such that when the saw blade 30 performs the cut processing of the work-piece 31, the driving side backup support 7 and driven side backup support 20 are moved along the backup supports guide rails 8 and 21 by the respective actuators 10 and 23, so that the driving side backup roller 13 and the driven side backup roller 26 move to positions as near as the external side of the work-piece 31 along the external shape of the work-piece 31(the external shape data input in advance or the side shape detected by the sensor).

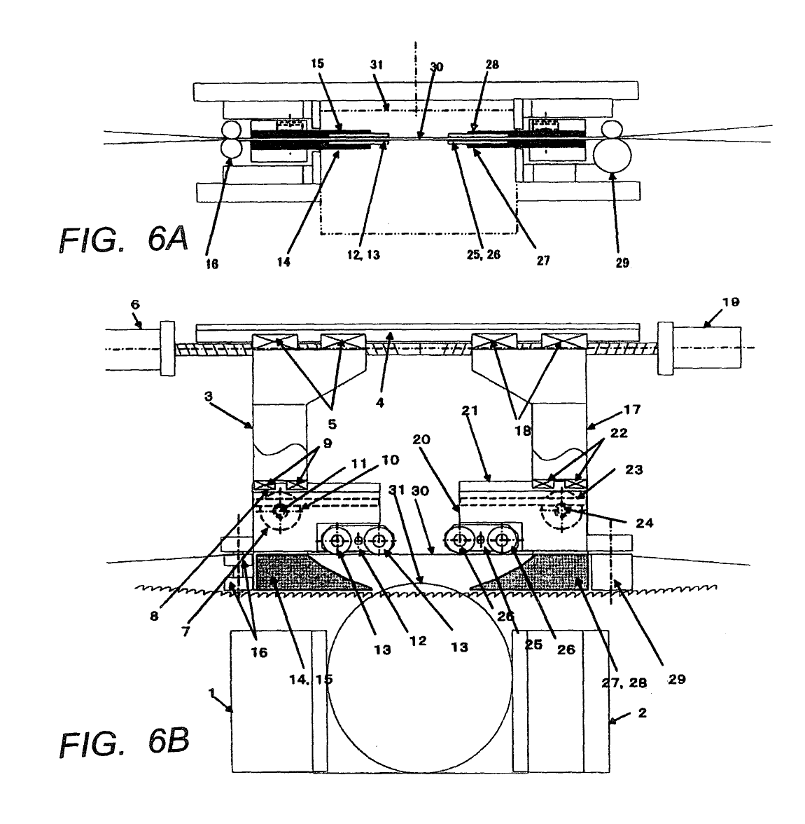

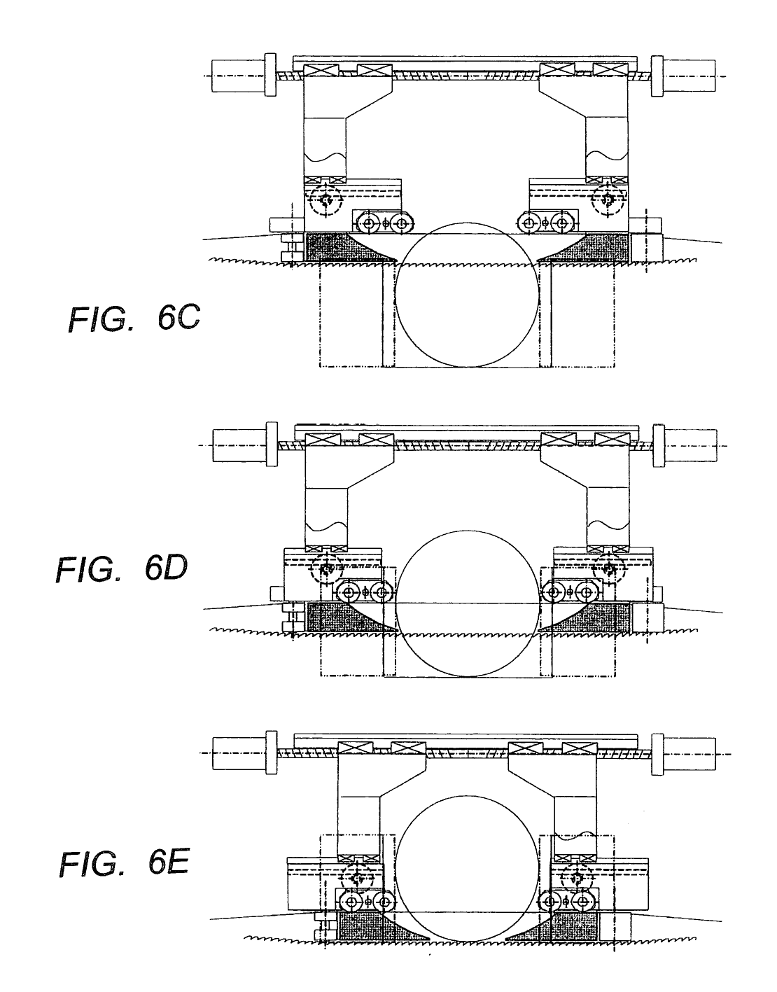

The action cutting the work-piece 31 in embodiment 1 in which the band saw machine having an abovementioned structure is used will be described in detail with reference to FIG. 4 to FIGS. 6A-E.

In FIG. 4, as shown by the chain line, at the cutting start position on the upside of the work-piece 31, the interval between the driving side insert plates 14, 15 and the driven side insert plates 27, 28 is in the minimum separation. Then, when the saw blade moves in the direction of cutting gradually, the driving side insert plates 14, 15 and the driven side insert plates 27, 28 move apart from each other along the external side of the work-piece 31. At the same time, the driving side backup roller 13 and the driven side backup roller 26 support the back of the saw blade 30 along the external side of the work-piece 31, thereby continuing the cutting forward.

After that, when the saw blade 30 is at the stage of cutting the lower half part after passing the cutting center point of the work-piece 31, the driving side insert plates 14, 15 and the driven side insert plates 27, 28 move close together along the external side of the work-piece 31. Because the end of the insert plates 14, 15, 27 and 28 have a shape of an arc cutting out from a rectangle, and the arc part has a tapered inclined surface, the end can get into under the work-piece 31, therefore, the saw blade 30 can be supported by the insert plates 14, 15, 27 and 28 in an optimum interval until to the final cutting point.

According to the embodiment described above, the supporting interval can be shortened even after the saw blade 30 has passed the center point of the work-piece 31 by means of enabling the left and right two insert plates get into under the work-piece 31 along the external side of the work-piece 31, therefore, the saw blade 30 can be supported firmly.

Next, modifications of the embodiment 1 will be described. In the modifications, the same reference numerals are assigned with the same structural elements as in embodiment 1, and have the same functions unless otherwise specified, and their explanation is omitted.

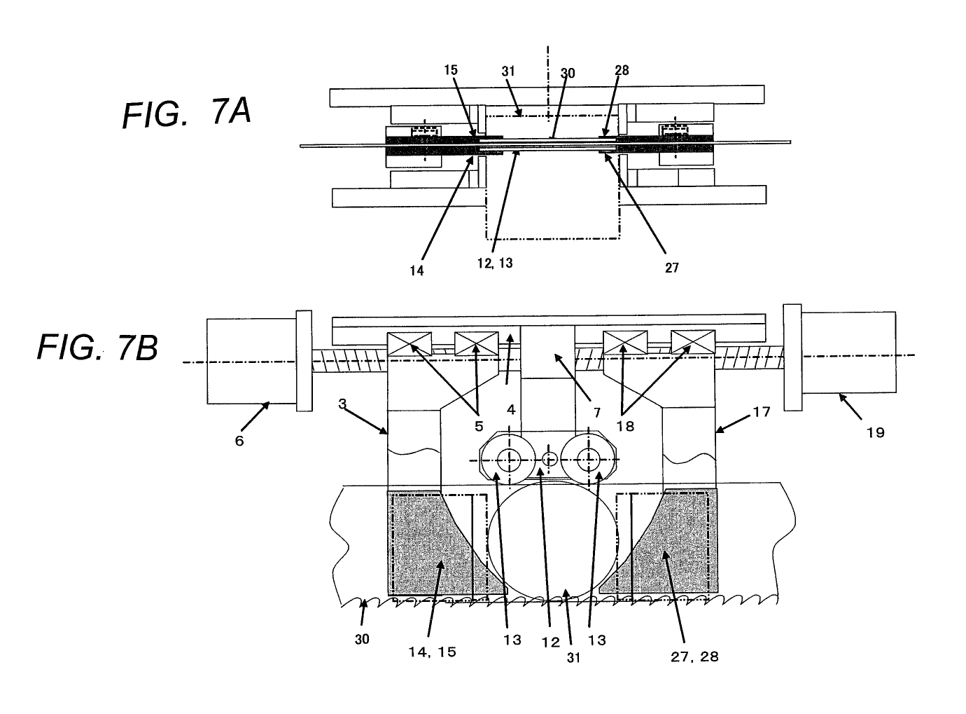

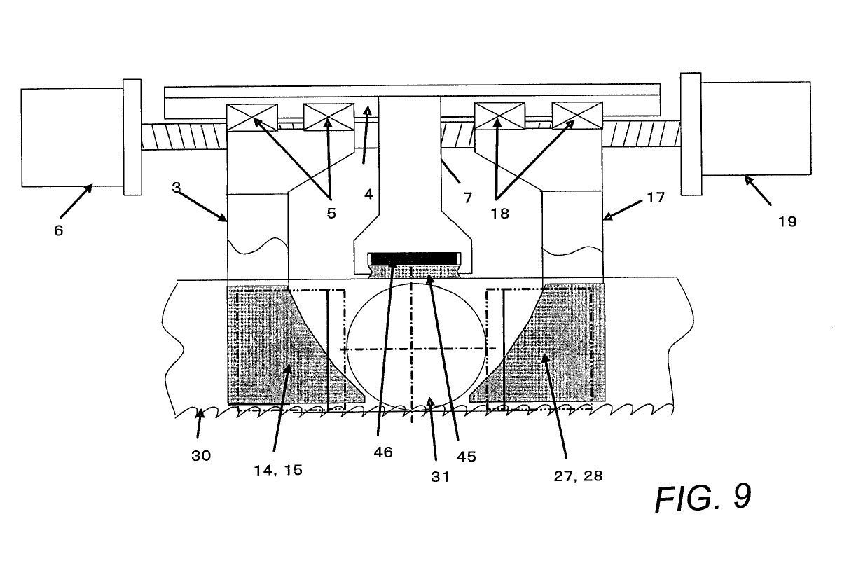

FIGS. 7A-B to FIG. 9 shows modification 1 to 3. FIG. 7A and FIG. 7B show an example in which the height of the work-piece 31 is smaller than the width of the saw blade 30, wherein FIG. 7A is a plan view and FIG. 7B is a front view. The modification 1 has driving unit which is configured to fix the left and right positions of the saw blade back support namely the backup roller 13 at the center position of the work-piece 31 (do not move left and right, only move up and down), and allow the saw blade side supports namely the driving side insert plates 14, 15 and the driven side insert plates 27, 27 to move left and right.

In the modification 1, the driving side insert plates 14, 15 and the driven side insert plates 27, 28 move left and right independent of the backup roller 13 which supports the back of the saw blade 30 and support the saw blade 30 at the optimum positions.

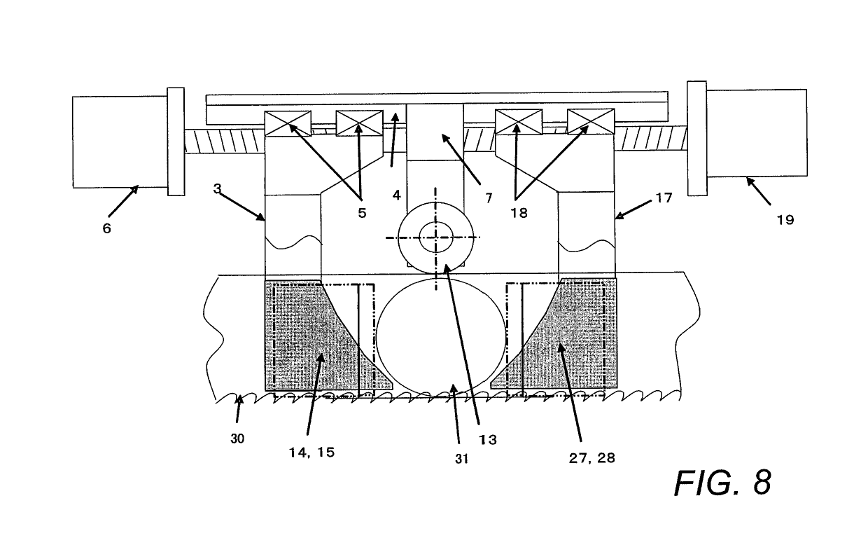

In addition, FIG. 8 shows the modification 2 as an application example of cutting the work-piece 31 having a smaller diameter as described above. In the modification 2, because the backup roller 13 consists of only one roller and located at the center position of the work-piece 31, the back force component is borne by the axis of the shaft, therefore, it possible to take a supporting manner similar to a supper-hard circular saw machine. Accordingly, it is possible to perform a smooth cutting for the work-piece 31 with a small diameter, which is unable to achieve by a supper-hard circular saw machine, and improve the cutting performance surpassing the supper-hard circular saw machine.

FIG. 9 shows another modification 3. This modification is an example using a backup chip 45 as the saw blade back support instead of the backup roller described above. Even using such a backup chip 45 a large back force component from the saw blade 30 still can be borne.

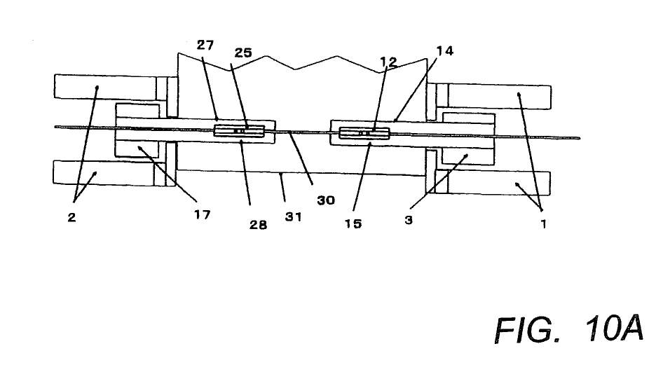

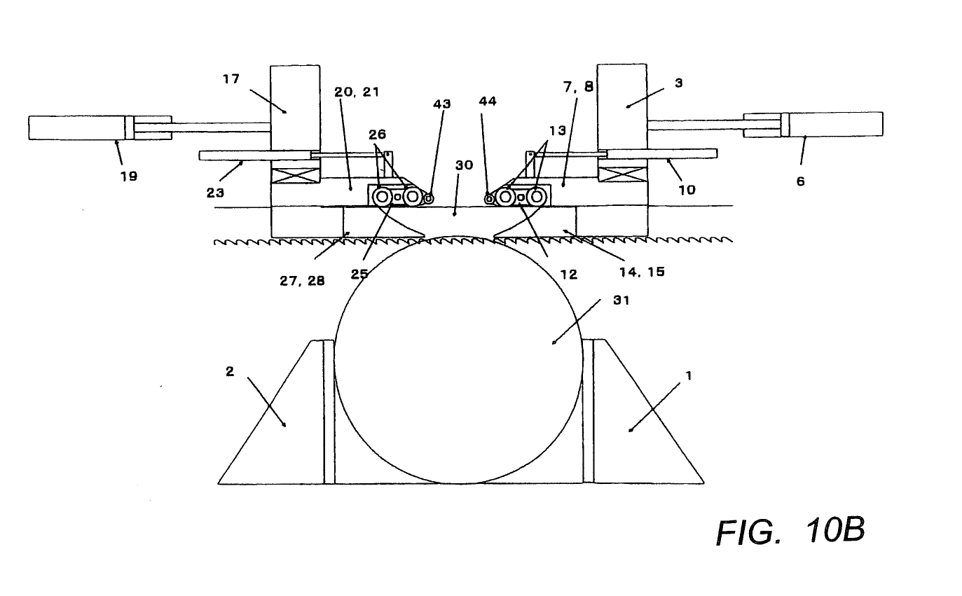

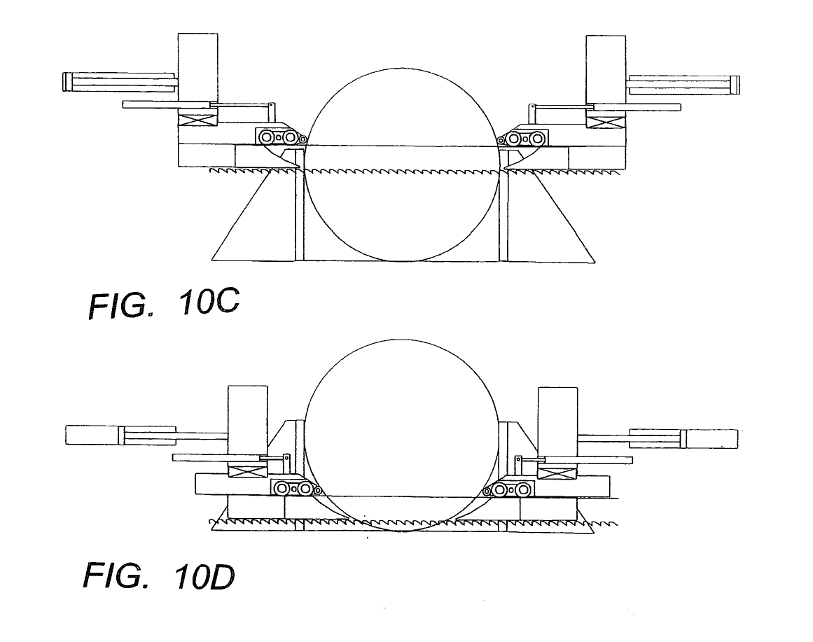

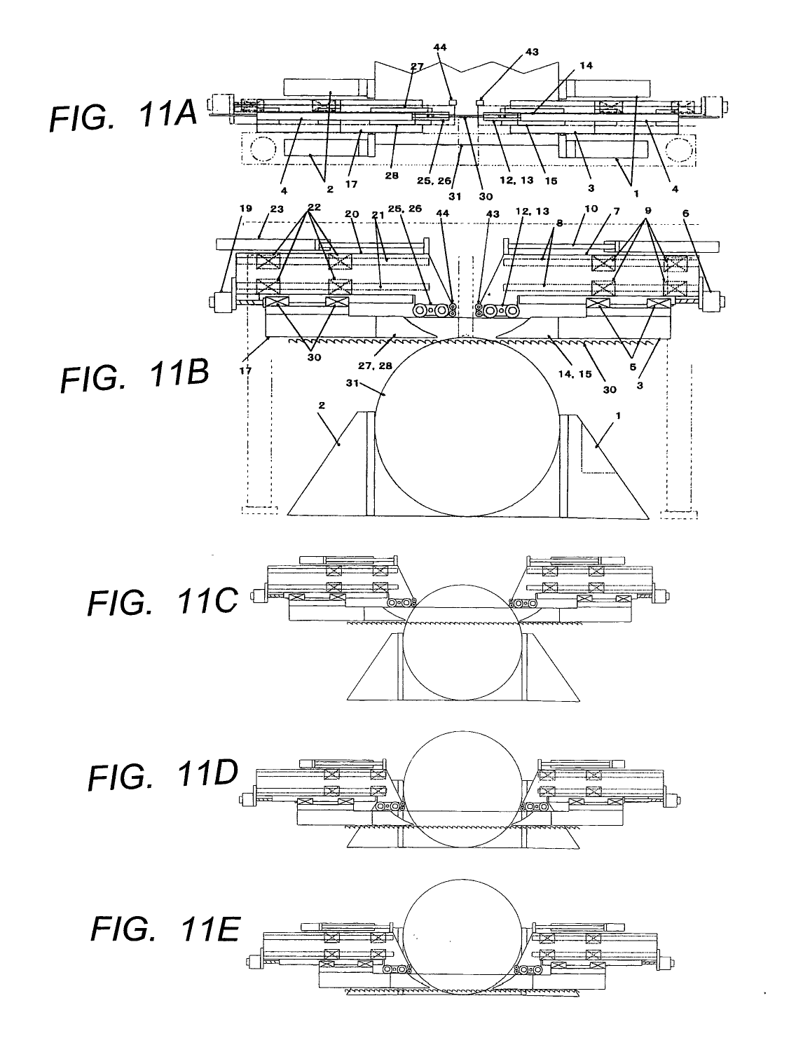

FIGS. 10A-D and FIGS. 11A-E show other modifications 4, 5. In modifications 4, 5, the same structural elements are assigned with the same reference numerals as in embodiment 1 are identified by like numerals, and have the same functions unless otherwise specified, and their explanation is omitted.

FIG. 10A and FIGS. 10B-D are illustration diagrams showing the action of the saw blade support device of the saw blade 30 in the process of cutting the work-piece 31 with the saw blade 30 in the modification 4, wherein FIG. 10A is a plan view and FIG. 10B-D are front views which show the action of the cutting process of the work-piece in time sequence.

In the modification 4, the guide arms 3, 17 take L-shape and project to the work-piece, so that the insert plates mounted on the guide arms can get into under the work-piece 31 more deeply while the cutting continues forward after passing the center of the work-piece 31 having a large diameter. Further, there is a sensor for detecting the external shape of the work-piece 31, and the insert plates move according to the detecting result of the sensor. In the modification 4, using as a sensor, a driving side work-piece detecting roller 43 and a driven side work-piece detecting roller 44 are added to the end of the backup supports 7, 20 in the actuators 6, 19 10 and 23 indicated in modification 1, therefore, the external shape can be detected correctly in the form of intimate contact with the work-piece 31.

FIG. 11A and FIGS. 11B-E are illustration diagrams showing the action of the saw blade support device of the saw blade 30 in the process of the cutting work-piece 31 with the saw blade 30 in another modification 5, wherein FIG. 11A is a plan view and FIG. 11B-E are front views which show the action of the cutting process of the work-piece.

The modification 5 is configured such that the backup supports 7, 20 mounted on the saw frame 33 by guide blocks 9, 22 are moved in the direction orthogonal to the cutting direction of the work-piece 31 with respect to the saw frame 33 by the actuators 10, 23. On the other hand, the guide arms 3, 17 mounted on the backup supports 7, 20 by the guide blocks 5, 30 are moved in the direction orthogonal to the cutting direction of the work-piece 31 by the actuators 6, 19. Accordingly, when cutting the work-piece 31, the insert plates 14, 15 and 27, 28 and the backup rollers 13, 26 can still be located at the position near the cutting site along the external side of the work-piece 31 even if the saw blade 30 continues the cutting forward after passing the center of the work-piece 31. Furthermore, as the case of modification 4, there is a sensor for detecting the external shape of the work-piece 31, therefore, the saw blade support device namely the insert plates 14, 15, 27, 28 and the backup rollers 13, 26 can move correctly according to the detecting result of the sensor.

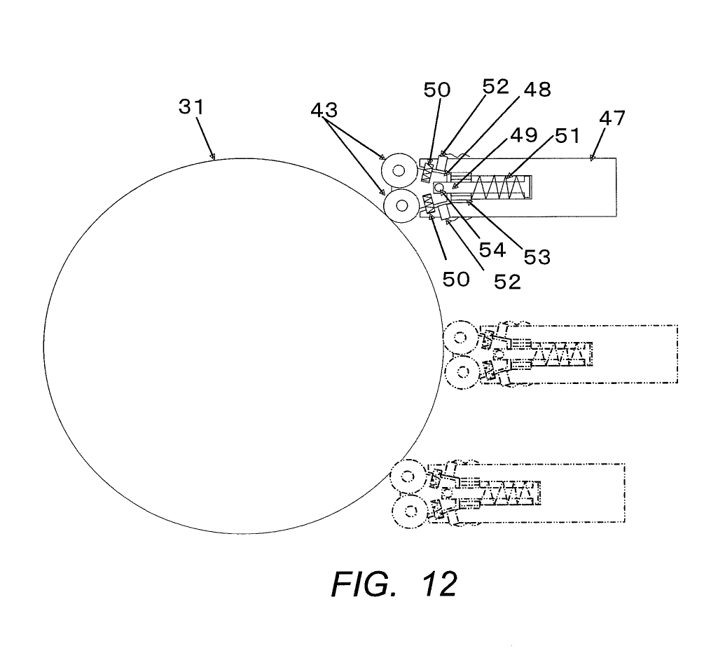

FIG. 12 is an illustration diagram showing an example of the structure and the action of the work-piece detecting rollers 43, 44 relating to this embodiment. As showed in FIG. 12, a hinge rod 49 projecting toward the work-piece 31 is provided on the end toward the work-piece 31, and a pin 54 connecting a roller block 48 in a free rotating way is mounted on the end of the hinge rod 49 toward the work-piece side. By using the pin 54, the roller block 48 is mounted in such a way that the end of the roller block 48 is located at a recessed position compared with the work-piece detecting roller 43. Therefore, at the rear of the work-piece detecting roller 43, the roller block 48 is connected to a pair of up and down compression springs 50 through the pin 54 which makes the roller block 48 rotating freely, and supported by the hinge rod 49 which is pulled to the opposite direction of the work-piece 31 in a floating state by a compression spring 51.

When cutting the work-piece 31, the work-piece detecting roller 43 contacts with the work-piece 31 by lowering the saw blade 30, and the displacement of the work-piece detecting roller 43 is detected by a sensor 52 mounted on the sensor body 47, so that the saw blade support device namely the insert plate and the backup roller can be controlled to be always located at the position near the work-piece along the external side of the work-piece 31.

In this modification, although the contact type detecting roller is illustrated as a sensor for detecting the external shape of the work-piece 31, it is possible to use all other type of sensors such as non-contact type sensors using infrared ray etc.

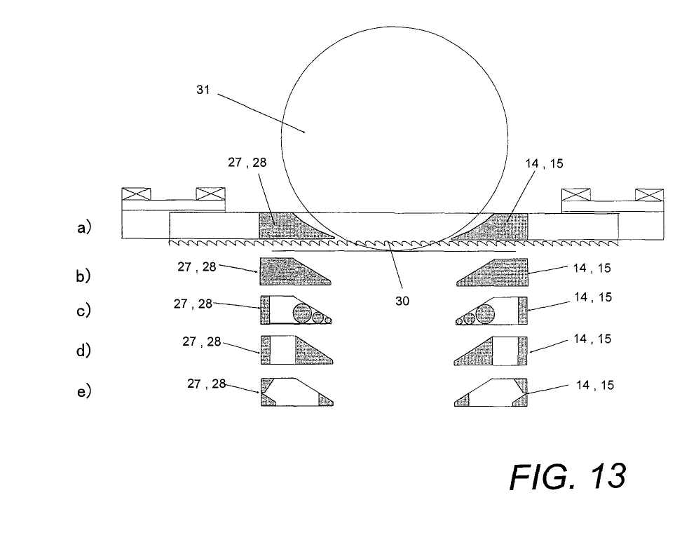

Furthermore, as some specific examples of the structure of the insert plates 14, 15, 27, 28 used as the saw blade side supports relating to the present invention are shown in detail in FIG. 13(a) to FIG. 13(e). The shape and structure of the insert plates 14, 15, 27, 28 can be changed to various type according to the feature such as shape and materials of the work-piece 31.

For example, the insert plate made of super-hard alloy or ceramics shown in FIG. 13(b) has a tapered trapezoidal shape at the front end potion toward the work-piece thereof. The insert plate shown in FIG. 13(c) is configured such that, on the trapezoidal base plate as indicated by the hatching, a plurality of circular-shaped supper-hard alloys or ceramics are pasted at the front end potion thereof and a rectangle-shaped supper-hard alloy or ceramics is pasted at the rear end potion thereof. The insert plate shown in FIG. 13(d) is configured such that, on the trapezoidal base plate as indicated by the hatching, a triangle-shaped supper-hard alloy or ceramics is pasted at the front end potion thereof, and a rectangle-shaped supper-hard alloy or ceramics is pasted at the rear end potion thereof. The insert plate shown in FIG. 13(e) is configured such that, on the trapezoidal base plate as indicated by the hatching, a triangle-shaped supper-hard alloy or ceramics is pasted at the front end potion thereof and a plurality of triangle-shaped supper-hard alloys or ceramics are pasted in a different direction at the rear end potion thereof. By keeping such a various insert plates on hand, different insert plates can be used selectively according to the saw blade and the feature of the work-piece 31 such as shape and materials etc.

### Embodiment 2

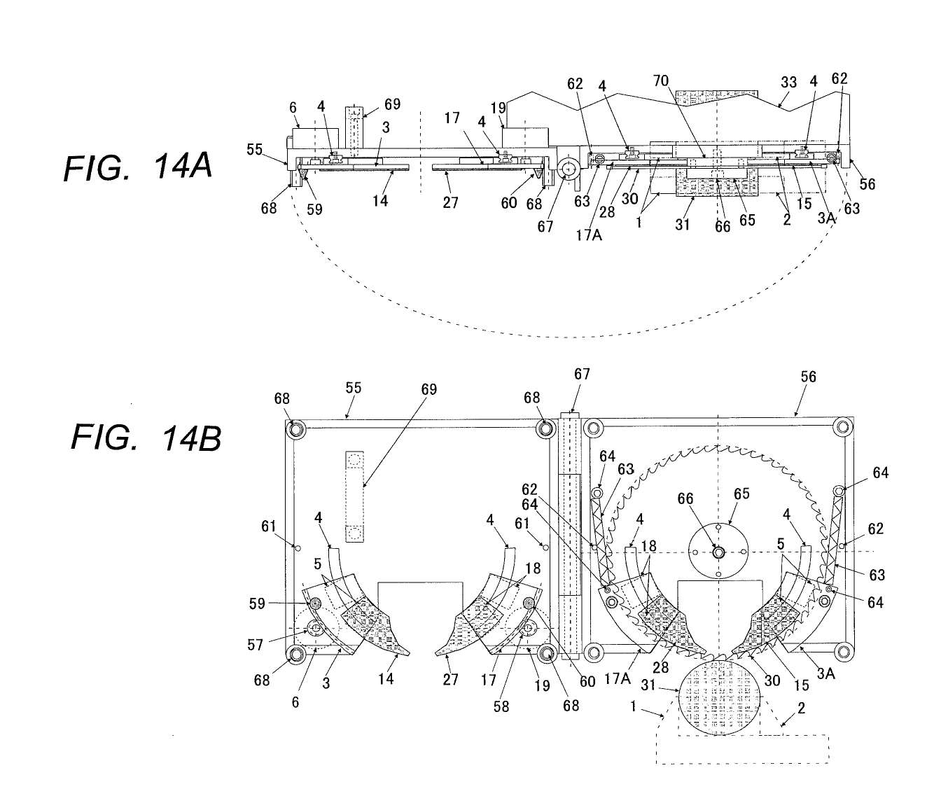

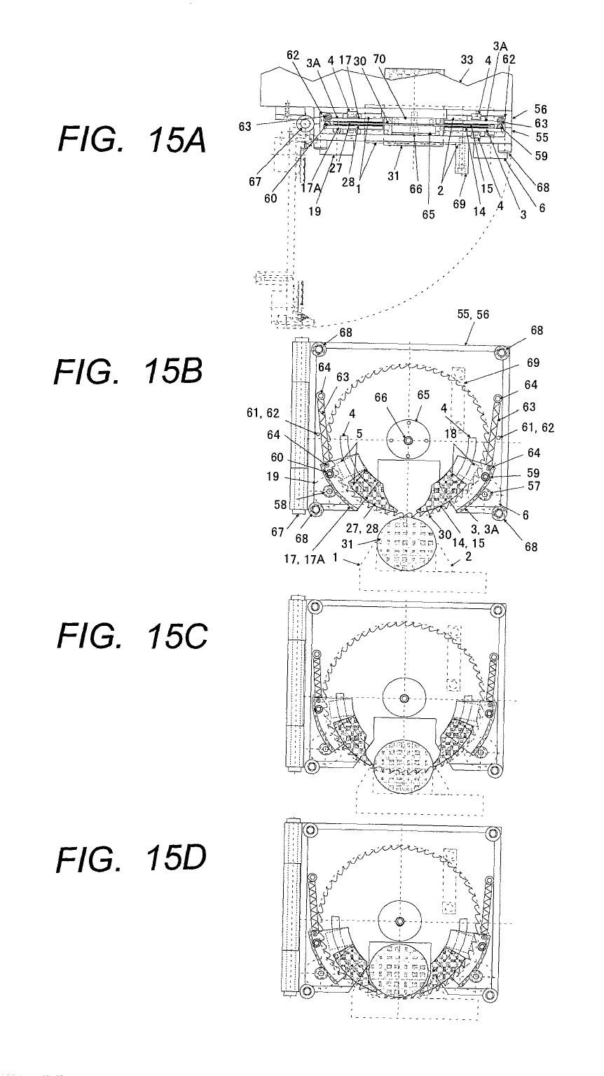

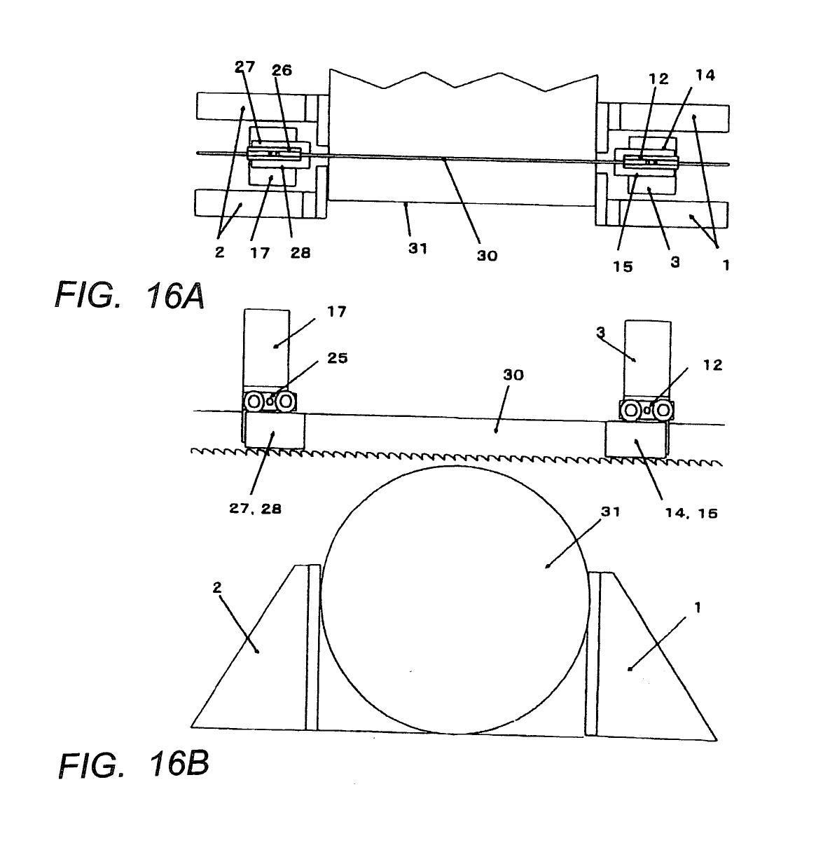

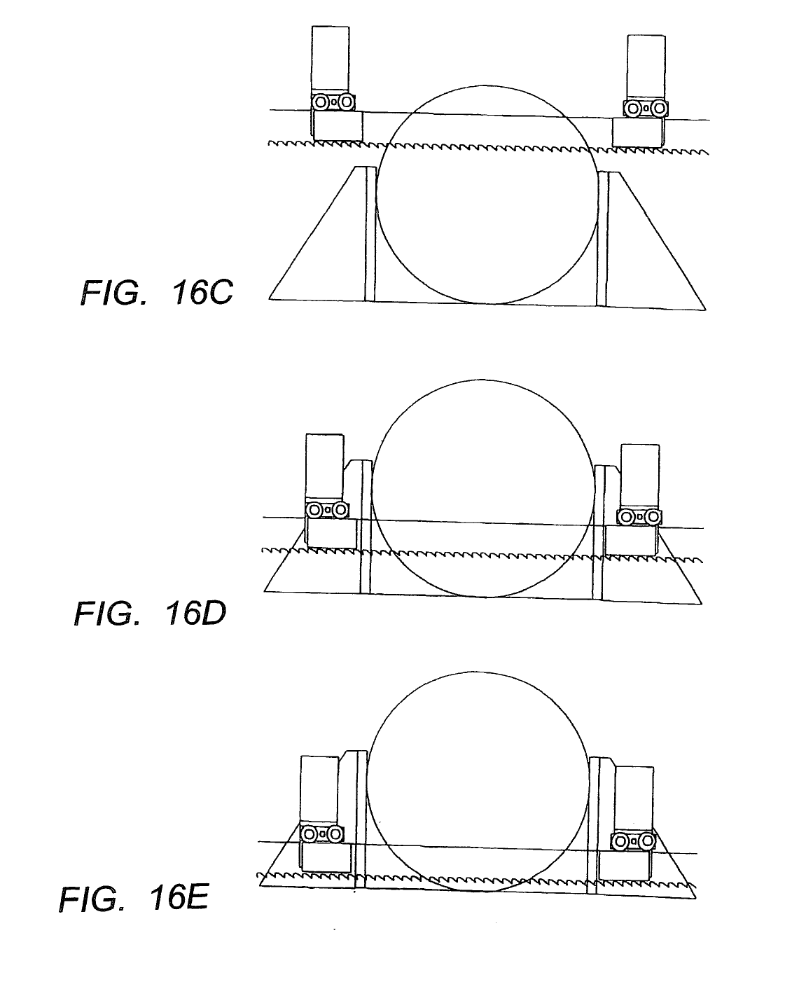

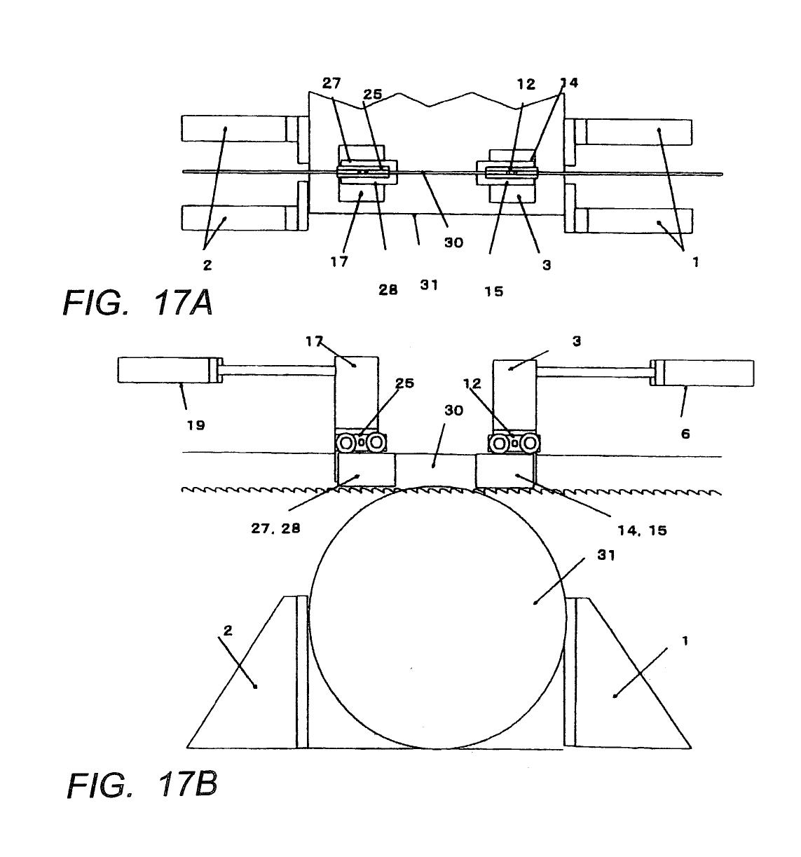

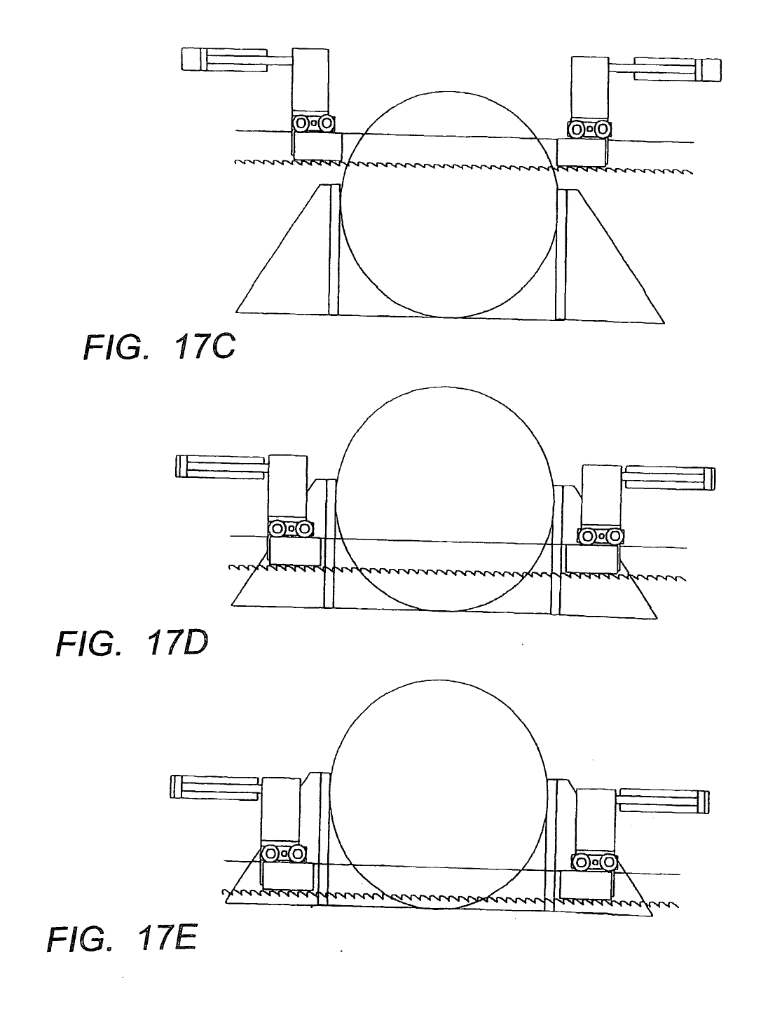

The embodiment 2 in which the saw blade support device relating to the present invention is applied to a circular saw machine will be described in detail with reference to FIGS. 14A-B and FIGS. 15A and 15B-D. FIG. 14A is a plan view of a circular saw machine relating to the embodiment 2 with a saw blade cover of the saw frame portion opened 180° and FIG. 14B is a front view.

The circular saw machine includes a feeding device (not shown in figure) for carrying work-piece 31, a body vice device for fixing the work-piece 31 and a cut processing portion for cutting the work-piece 31. The feeding device includes a roller table equipped with a plurality of free rotating rollers and a feeding vice unit for carrying the work-piece on the roller table to the saw blade position. The body vice device comprises a body fixed vice 1 and a body moveable vice 2 for clamping and fixing the work-piece. Specifically, as shown by chain line in FIG. 14, the work-piece 31 is fixed by clamping it with the body fixed vice 1 and the body moveable vice 2 from both sides.

The cutting of the work-piece 31 is performed by rotating the circular saw blade 30 mounted on a saw frame side flange 70 of the saw frame 33 by using a saw blade fixing flange 65 and a saw blade fixing flange bolt 66. Specifically, the circular saw blade 30 provided on the saw frame 33 enabled to move up and down with respect to a base table namely a base column (not shown in figure) is rotated by a saw blade driving motor and reducer (not shown in figure), at the same time, the saw frame 33 is moved down along the saw frame guide rail or the hinge by a saw frame up and down actuator, thereby, enabling the saw blade 30 to cut the work-piece 31.

The blade edge of the saw blade 30 is provided with insert plates (driving side insert plates 14, 15 and driven side insert plates 27, 28) used as the saw blade side supports which support the saw blade 30 from both sides, and has actuators 6, 19 and 11, 24 used for moving the guide arms 3, 17 and 3A, 17A equipped with the insert plates in the direction orthogonal to the cutting direction of the work-piece.

The guide arms are placed in a guide rail 4 through guide blocks 18, 59 and 5, 18. The guide rail 4 is fixed on saw blade covers 55, 56, and the saw blade cover consists of a saw blade cover body 56 fixed on the saw frame 33 and a open side saw blade cover 55 connected with the saw blade cover body 56 by a hinge pin 67. Furthermore, a saw blade cover open handle 69 is mounted on the saw blade cover 55. The saw blade covers 55 and 56 are opened in the case of changing or checking the circular saw blade 30, and closed in the case of cutting the work-piece 31 with a saw blade cover fixing bolt 68, so that the circular saw blade 30 is supported by the insert plates 14, 15, 27, 28 from both sides.

The driving side insert plates 14, 15 and the driven side insert plates 27, 28 are the saw blade side supports which support the blade edge of the saw blade 30 from both sides, and prevent the blade edge of the saw blade 30 from bending due to the cutting load in cutting and always vertically contact with the work-piece.

The shape and structure of the driving side insert plates 14, 15 and the driven side insert plates 27, 28 are similar to that in embodiment 1 and its modifications, the end of the insert plates toward the woke-piece side takes a shape of tapered inclined surface, so that it can be located within the maximum width of the work-piece. As in the case of embodiment 1 and its modifications, when performing the cutting, the insert plates move down together with the saw frame in the cutting direction and meanwhile move in the direction orthogonal to the cutting direction of the work-piece along the external side of the work-piece.

The driving side insert plates 14, 15 and the driven side insert plates 27, 28 are fixed on the guide arms 3, 3A and guide arms 17, 17A respectively. When the saw blade cover 55 is opened, the guide arms 3, 17 are moved back to the position contacting with an end stopper pin 61 by the actuators 6, 19, and the guide arms 3A, 17A are moved back to the position contacting with an end stopper pin 62 by a reset spring 63. The reset spring 63 is an elastic member which is connected with the saw blade cover body 56 and the guide arms 3A, 17A by spring fixing bolt 64, and apply a force to the guide arms 3A, 17A upward in tangential direction of the saw blade 30. When the saw blade cover 55 is closed, the guide arms 3 and 3A are connected with the guide arms 17 and 17A respectively through the cone-shaped connecting pin 59.

The guide arms 3, 3A and 17, 17A shown in FIGS. 14A-B have a part of a round rack gear formed thereon, and move in the direction orthogonal to the cutting direction along the guide rail 4 by rotating the pinions 57, 58 mounted on the actuators 6, 19. Furthermore, the guide arms 3, 3A and 17, 17A could be actuated by direct-acting cylinder actuator.

Referring to FIG. 15A and FIGS. 15B-D, the action of cutting the work-piece 31 by using a circular saw blade in which the embodiment 2 with the abovementioned structure is applied will be described in detail. According to the connection structure described above, the insert plates 14, 15, 27, 28 are positioned on the left and right sides of the cutting portion of the saw blade. As shown in FIGS. 15B to 15D, when cutting the work-piece 31, the insert plates 14, 15, 27, 28 together with the saw frame 33 move in the cutting direction, and at the same time, the actuators 6, 19 make the insert plates 14, 15 and 27, 28 move apart from or close to each other at the left and right sides of the work-piece 31 in the direction orthogonal to the cutting direction and along the external side of the work-piece 31. As shown in FIG. 15D, since the end of the each insert plate takes a tapered shape, the insert plate can get into under the work-piece 31. Furthermore, the actuators 6, 19 are controlled respectively according to the shape of the work-piece and the cutting manner of the saw frame, and also the insert plates could move respectively along the external side of the work-piece 31.

Although it is not shown in detail in the figures, as in the case of in embodiment 1 and its modifications, the external shape of the work-piece 31 can be detected by a sensor, and the movement of the insert plates could be controlled based on the detecting result also in the embodiment 2.

While the embodiments of the present invention have been described above, it will be understood that the invention is not limited by the embodiments described above, and various modifications can be made within the technical scope set forth in the claims.

What is claimed is:

1. Sawing machine for cutting a work-piece with a saw blade, comprising:
a saw blade supporting device;
a pair of saw blade side supports for supporting the saw blade from both sides;
a moving unit for moving the saw blade side supports along the external side of the work-piece and in the direction orthogonal to cutting direction of the work-piece,
wherein each of the saw blade side supports is supported on the end portion of a guide arm in a manner of projecting toward the work-piece;
a sensor for detecting the external shape of the work-piece and/or a storage device for storing the external shape of the work-piece; and
the moving unit is controlled based on the detected result from the sensor or the external shape data in the storage device.

2. Sawing machine according to claim 1, wherein the saw blade side supports take a shape of tapered inclined surface so that an end portion toward the work-piece can be located within the maximum cutting width of the work-piece between the position of the saw blade passing the maximum cutting width of the work-piece and a position of a cutting end.

3. Sawing machine according to claim 2, wherein the tapered inclined surface takes a shape of a straight line, a combination of a plurality of straight lines or an arc in a side view conforming to an outer shape or an external side of the work-piece.

4. Sawing machine according to claim 1, wherein the saw blade is a revolving band saw blade or a circular saw blade including a rotating plate.

5. Sawing machine according to claim 1, wherein the saw blade side supports are disposed at two positions on left and right of the work-piece.

6. Sawing machine according to claim 5, wherein the saw blade side supports disposed at two positions on left and right are respectively connected to the moving units that are independent, and the moving units are controlled independently according to the outer shape or geometry of an external side of the work-piece.

7. Sawing machine according to claim 1, wherein the saw blade side supports include insert plates made of super-hard alloy or ceramics.

8. Sawing machine according to claim 1, comprising a saw blade support device comprising a pair of driving and driven side insert plates and saw blade back supports, in particular driving and driven side back up rollers.

9. Sawing machine according to claim 1, wherein the driving side insert plates are movably mounted on a driving side guide arm and the driven side insert plates are movably mounted on the driven side guide arm.

10. Method for cutting a work-piece by a saw blade of a sawing machine comprising saw blade side supports for supporting the saw blade, wherein the saw blade is supported close to a work-piece at any time during the sawing process up to the end thereof, controlling the positioning of at least one of the saw blade side supports close to an outer contour of the work-piece even after passing a maximum dimension of the work-piece where a cutting length of the saw blade cutting the work-piece is maximum.

11. Method according to claim 10, wherein the opposite saw blade side supports approach each other after passing the maximum dimension and area of maximum cutting length of the saw blade at the work-piece.

12. A cutting method of a sawing machine for cutting a work-piece with a saw blade, wherein saw blade side supports for supporting the saw blade from both sides are moved along the external side of the work-piece and in the direction orthogonal to the cutting direction of the work-piece by using a moving unit;
each of the saw blade side supports is supported on the end portion of a guide arm in a manner of projecting toward the work-piece;
the saw machine has a sensor for detecting the external shape of the work-piece and/or a storage device for storing the external shape of the work-piece; and
the moving unit is controlled based on the detected result from the sensor or the external shape data in the storage device.

13. Cutting method of a sawing machine according to claim 12, wherein the saw blade is a circular saw blade including a rotating plate or a revolving band saw blade.

14. Cutting method of a sawing machine according to claim 12, wherein the saw blade side supports are disposed at two positions on left and right of the work-piece.

15. Cutting method of a sawing machine according to claim 12, wherein the saw blade side supports disposed at two positions on left and right are configured to move independently, and the movement is controlled independently according to the external shape of the work-piece.
